(19) United States
(12) Patent Application Publication
(10) Pub. No.: US 2006/0218177 A1
(43) Pub. Date: Sep. 28, 2006

(54) System and method for storing and retrieving data through an inferencing-enabled metadata system

(76) Inventors: Yuan-Chi Chang, New York, NY (US); Juhnyoung Lee, Yorktown Heights, NY (US); Ioana Roxana Stanoi, White Plains, NY (US)

Correspondence Address: KEUSEY, TUTUNJIAN & BITETTO, P.C., 20 CROSSWAYS PARK NORTH, SUITE 210, WOOBURY, NY, 11797, US

(21) Appl. No.: 11/089,841

(22) Filed: Mar. 25, 2005

(51) Int. Cl. G06F 7/00

(52) U.S. Cl. 707/102

(57) ABSTRACT

A system and method, which registers and stores data and is responsive to queries through management of an inferencing-enabled metadata includes an intelligent database, which receives data or queries and manages data models. An ontology management system is associated with the intelligent database and receives and stores classes of information related to a data model therein to be employed in satisfying queries. A relational database is associated with the intelligent database and receives and stores attribute schema for instances of the class having at least one attribute value linked with the class in the ontology management system.

### BACKGROUND

1. Technical Field

The present invention relates to storing, retrieving and querying data from ontology and relational databases, and more particularly, to the application of semantic inferencing to enhance the flexibility of data models while continuing to leverage scalability and query efficiency of relational databases.

2. Description of the Related Art

Relational databases are prevalently used in applications that require persistent storage of structured data. Numerous enterprise applications, such as payroll, inventory, electronic commerce, etc. depend on the efficiency and reliability of a relational database to manage their data. The foundation theory behind relational databases is relational algebra, which defines transformation rules that convert, without loss, one set of relational data structures (or tables) to another. The same theory is also used to convert one query to other equivalent forms, which all return with the same results.

A significant engineering effort to use relational databases is taken by architecting the data model and its mapping to relational data structures (tables).

Until recently, an architected data model in an application is rarely changed during its lifetime. Altering the data model usually results in changes, which propagate through the application's data access layer, business logic and even user interface. The significant overhead of change propagation comes with high cost of consulting services for customization. Application users often wait for the next release of the software to migrate to the new data model, and the migration process is often error prone.

Increasingly, enterprise applications are needed to adapt to the rapid changing business needs due to outsourcing, transformation, merger and acquisition. Changing business needs demand changes from user interfaces, business logic, business data and their respective models. Enhancing the flexibility of data model adaptation is a necessary step to enable adaptive enterprise applications.

### SUMMARY

A system and method, which registers and stores data and is responsive to queries through management of an inferencing-enabled metadata, includes an intelligent database, which receives data or queries and manages data models. An ontology management system is associated with the intelligent database and receives and stores classes of information related to a data model therein to be employed in satisfying queries. A relational database is associated with the intelligent database and receives and stores attribute schema for instances of the class having at least one attribute value linked with the class in the ontology management system.

These and other objects, features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a graphical illustration of the relationship between the present invention and its use of known technologies;

FIG. 2 is a flow diagram for creating a new class in the intelligent database;

FIG. 3 is a flow diagram for creating new instances associated with an entity;

FIG. 4 is a graphical illustration of three ontology classes and their associated attribute schema;

FIG. 5 is a graphical illustration of ontology classes defined in FIG. 4 and their instances; and

FIG. 6 is a flow diagram of the query processing process in answering an example query.

### DETAILED DESCRIPTION OF PREFFERED EMBODIMENTS

The fast changing business environment demands information technology (IT) infrastructure to be flexible without sacrificing performance. The requirements propagate from users, business processes, applications to database middleware. Traditional data model design and use is conventionally rigid and static. The present invention brings together the flexibility of an ontology management system and the scalability of a relational database to accomplish adaptive evolution of a data model. Elements of the data model are managed as classes and instances in the ontology while attributes are stored in relational schema such as tables. Inferencing relationships among ontology instances provide semantically meaningful query interfaces while processing-intensive attribute predicates are handled by a relational database engine. The hybrid database delivers flexibility and scalability.

The present invention addresses data model adaptation by introducing ontology to capture and store relationships explicitly. Ontology may be defined as the knowledge representation to describe the kinds of concepts in the world and how they are related. Explicitly represented relationships enable dynamic manipulations by adding or deleting relations, which are not currently possible with conventional relational data models. Furthermore, properties of relationships such as transitive and inverse, enrich queries with inferencing, which are also not available with conventional relational data models.

Inferencing is the process of drawing logical conclusions from premises using rules. For example, Mary is the “parent of” Chad. The “parent of” relationship is the inverse of the “child of” relationship. Therefore, a query asking for the “child of” Mary can be inferenced for the answer “Chad”.

While relationships may be explicitly captured in ontology, attributes of data entities are stored in the relational database for efficiency in accordance with the present invention. This is consistent with relational data modeling.

The present invention is directed to systems and methods for creating, updating, deleting, querying and retrieving a data model and its instance values through a hybrid use of an ontology management system and a relational database system. Illustrative embodiments described herein enable elements and relationships in a data model to be managed by ontology to achieve flexibility. This enables instance values associated with elements in the data model to be managed by relational database to achieve storage and query efficiency.

Particular aspects of useful embodiments are related to, e.g., (1) create a new class in the ontology and its associated attribute schema in the database; (2) specify the relationships between this new class and other existing classes in the ontology; (3) insert a new instance associated with an existing class into the ontology and store attribute values of the new instance into the class-associated database schema; (4) delete an existing instance by removing its entry and relationships from the ontology and by deleting its attribute values from the database; (5) query and retrieve one or more instances by first evaluating the inferencing section of a query through ontology and then evaluating the attribute predicate section of a query through relational database. This list is not exhaustive, but is presented to provide some of the capabilities provided in accordance with this disclosure.

It should be understood that the elements shown in the FIGS. may be implemented in various forms of hardware, software or combinations thereof. Preferably, these elements are implemented in a combination of hardware and software on one or more appropriately programmed general-purpose digital computers having a processor and memory and input/output interfaces.

It is to be appreciated that the term “database” as used herein refers to relational database, such as for example, an IBM DB2 or Oracle 10g database. Other databases may also be employed. The term “ontology” as used herein may refer to ontology management software that inserts, deletes and inferences facts.

The term “class” in an ontology as used herein refers to defined concepts in a domain. For example, one may define the concept of “teacher” to be a class. The term “instance” of a class as used herein refers to the materialization of the concept. For example, “Mr. Smith” is an instance of “teacher”. The term “attribute” of a class as used herein refers to defined properties of the class. For example, the class “teacher” has attributes including name, course, office, phone and salary.

The term “relationship” as used herein defines relations between instances of one or more classes. For example, the class “school” has the “employ” relationship with the class “teacher”. The creation and applications of classes and relationships reflect the data model desired by human developers. In general, there is no set engineering procedure or methodology for data model inception or its creation.

For ease of illustration and description, a hypothetical example of three classes and their associated attribute schema is used in an illustrative embodiment of the present invention. The present invention should not be viewed as limited or constrained to the example given or the size of the example.

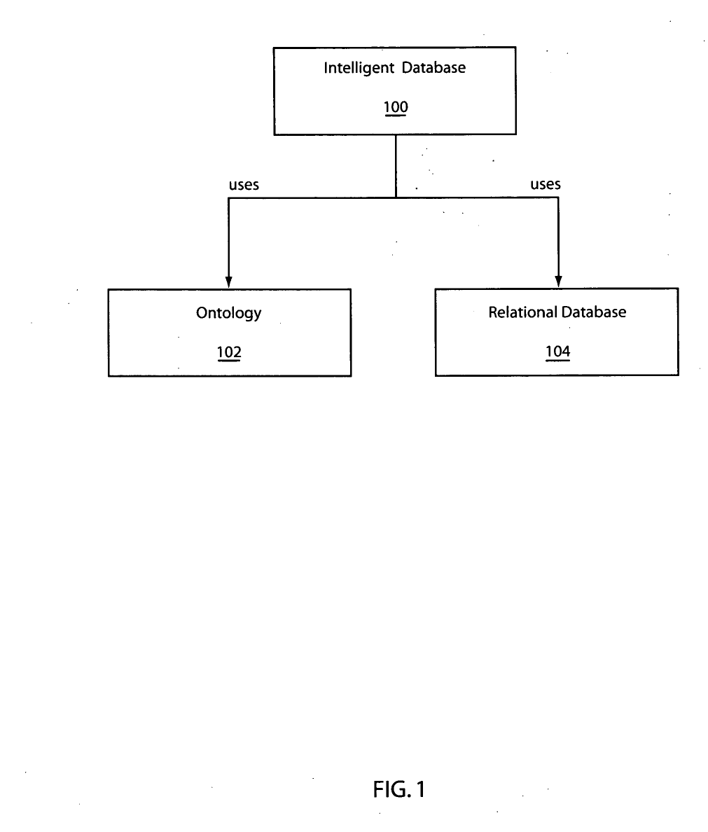

Referring now in detail to the figures in which like numerals represent the same or similar elements and initially to FIG. 1, a relationship between an intelligent database 100, an ontology 102 and a relational database 104 are illustratively depicted. Intelligent database 100 uses ontology 102 and relational database 104 to store and manage data in a flexible and scalable way. Intelligent database 100 uses ontology 102 and relational database 104 to achieve capabilities and features not provided by conventional systems. Intelligent database 100 incorporates or associates with ontology 102 and relational database 104 to store and retrieve data in a more efficient and scalable way. In one embodiment, intelligent database 100 receives queries and returns a result based upon an inferencing portion of the query. Next, an attribute predicate portion of the query is employed with the inferencing result to return a result to the initial query. Further details will be described hereinafter.

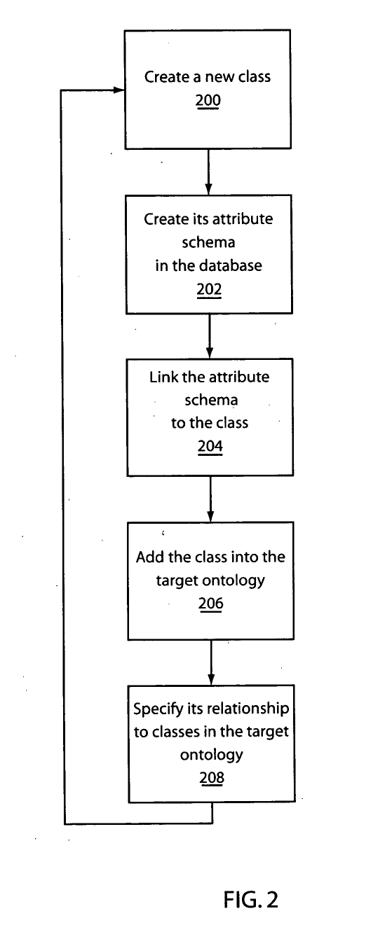

Referring to FIG. 2, a block/flow diagram illustrates exemplary steps an intelligent database employs in creating a new data model element. In block 200, a new class is created in the ontology to represent a new element. Creating a new class may be performed in a known way in the ontology management system. In block 202, intelligent database then creates attribute schema for the new element in the relational database. Creating a storage schema may be performed in a known way using the relational database system.

The intelligent database then keeps a record to link the class in the ontology management system with the attribute schema in the database in block 204. The newly created class is then added to a possibly existing target ontology in block 206. Alternatively, a new ontology space can be created to add the new class. If there are other existing classes in the target ontology, one may specify one or more relationships to these classes as well in block 208. Specifying such relationships may be performed by known methods in the ontology management system.

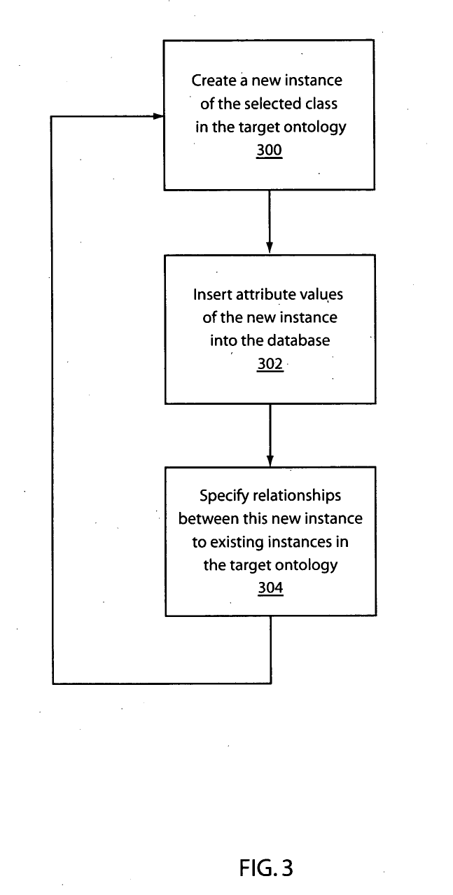

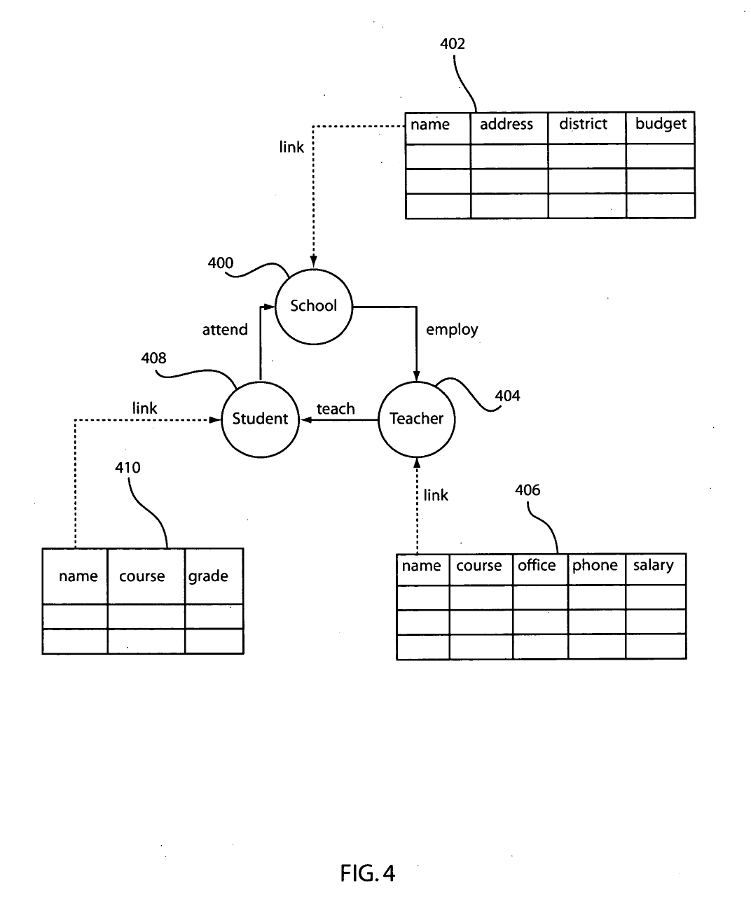

Referring to FIG. 4, three ontology classes and their attribute schema are illustratively shown. The three classes stored in ontology are “teacher” 404, “school” 400 and “student” 408. The specified relationships are “school” employ “teacher”; “teacher” teach “student”; “student” attend “school”. For the “school” class, its attribute schema 402 in the database stores name, address, district and budget. For the “teacher” class, its attribute schema 406 in the database stores name, course, office, phone and salary. For the “student” class, its attribute schema 410 in the database stores name, course and grade. After classes and schema are created, one can then insert instances in the series of steps as illustratively shown in FIG. 3.

Again, it is noted that the FIGS. and description can be generalized beyond the illustrative example classes and instances shown and described in accordance with the present disclosure.

Referring to FIG. 3, a new instance is associated with an existing class in ontology before the instance is created in block 300. Creating instances in ontology may be performed as is known in the art. In block 302, attribute values of the new instance are then inserted into the attribute schema, which is associated with the class, in the database. In the target ontology, relationships between the new instance and existing instances are created as needed in block 304. Creating instance relationships may be performed in ontology as known in the art.

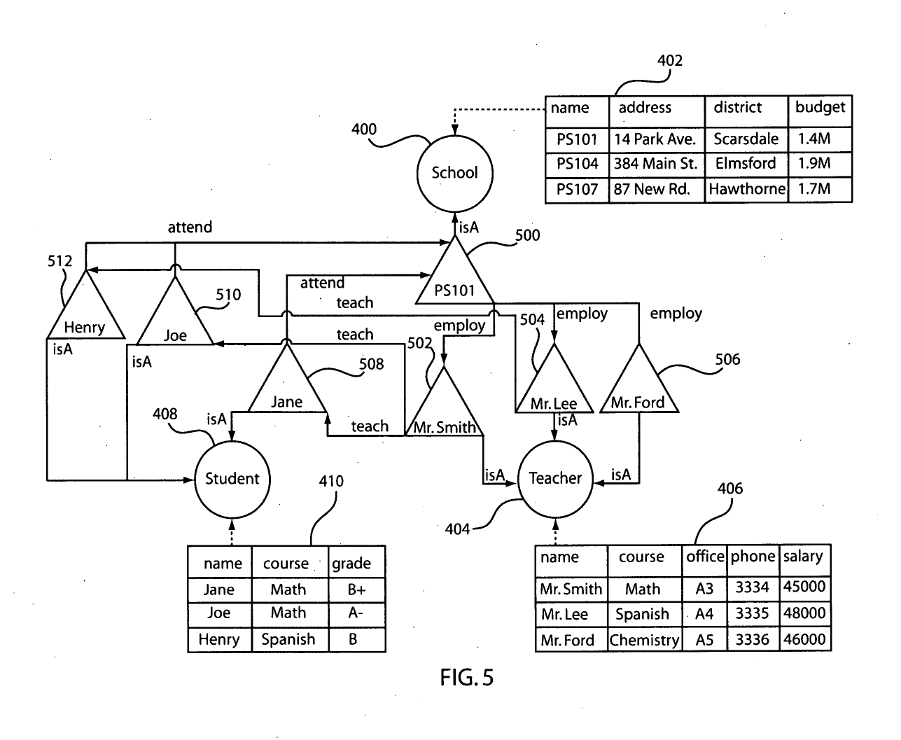

Referring to FIG. 5, a continuation of the example in FIG. 4 with seven instances created and populated is illustratively shown. Jane 508, Joe 510 and Henry 512 are instances of student 408 and they have courses and grades in table 410. Similarly, Mr. Smith 502, Mr. Lee 504 and Mr. Ford 506 are instances of teacher 404 and they have courses, offices, phones and salary information in table 406. These teachers are employed at PS101 500, which is an instance of school 400.

In FIG. 5, relationships among the instances are depicted with annotated arrows. For example, PS101 employs Mr. Smith, Mr. Lee and Mr. Ford. Jane, Joe and Henry attend PS101. Mr. Smith teaches Jane and Joe and Mr. Lee teaches Henry. The hybrid use of ontology management system and relational database enables both flexibility of the data model and scalability of the data store. It is easy to add new classes and instances, following the procedures in FIG. 2 and 3, so the data model can adapt to the needs of application software.

Attributes are stored in the relational database for efficient query and retrieval. For example, looking for teachers with a salary greater than 47,000 leverages relational range query.

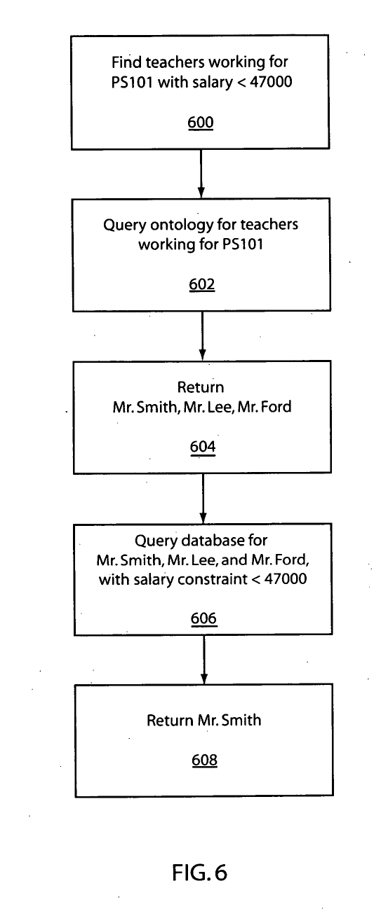

Referring to FIG. 6, an illustrative flow chart shows the steps in answering the query “find teachers employed by the school PSl01 with salary greater than 47000”. The present example is provided to demonstrate aspects and features of the present invention in a practical example. These steps may be generalized for any query.

In block 600, a query is posed to an intelligent database, which is associated with an ontology and a relational database. The present query includes an inferencing section or portion and an attribute predicate section or portion. The inferencing section is to find teachers employed by PS101. This inferencing query is answered first by ontology in block 602. The answers are Mr. Smith, Mr. Lee and Mr. Ford, which are returned in block 604. Salary is an attribute of the teacher class so “salary greater than 47000” is a predicate on attributes. The inferencing result, in conjunction with the attribute predicate, forms a relational database query as set forth in block 606. The relational query then returns Mr. Smith from the database in block 608, which satisfies the query.

Having described preferred embodiments of a system and method for storing and retrieving data through an inferencing-enabled metadata system (which are intended to be illustrative and not limiting), it is noted that modifications and variations can be made by persons skilled in the art in light of the above teachings. It is therefore to be understood that changes may be made in the particular embodiments disclosed which are within the scope and spirit of the invention as outlined by the appended claims. Having thus described aspects of the invention, with the details and particularity required by the patent laws, what is claimed and desired protected by Letters Patent is set forth in the appended claims.

What is claimed is:

1. A method to register and-store data through the management of an inferencing-enabled metadata system, comprising the steps of:
receiving a definition of an ontology class and attributes of the definition;
creating the ontology class in an ontology management system and creating attribute schema in a relational database; and
linking the ontology class in the ontology management system to the attribute schema in the relational database by providing at least one relationship therebetween.

2. The method as recited in claim 1, further comprising specifying inter-class relationships between the ontology class and existing ontology classes.

3. The method as recited in claim 1, wherein the ontology class and the attribute schema store at least a portion of a data model, and the method further comprising enabling flexibility and scalability of the data model by permitting storage of the data model in both the ontology management system and the relational database.

4. The method as recited in claim 1, further comprising deleting an existing instance by removing its entry and relationships from the ontology management system and deleting its attribute values from the attribute schema in the relational database.

5. A program storage device readable by machine, tangibly embodying a program of instructions executable by the machine to perform method steps to register and store data through management of an inferencing-enabled metadata system, as recited in claim 1.

6. A method to query data from an inferencing-enabled metadata system, comprising the steps of:
responsive to a query including an inferencing portion and an attribute predicate portion, issuing an inferencing query to an ontology management system and retrieving inferencing results; and
issuing a relational query by combining inferencing results and attribute predicate portion.

7. The method as recited in claim 6, wherein the results are provided from the inferencing-enabled metadata system which manages data by linking relationships between ontology class information in the ontology management system to associated attribute schema in the relational database.

8. The method as recited in claim 6, wherein the inferencing portion includes properties of relationships to enrich understanding of the query.

9. The method as recited in claim 6, wherein the attribute predicate portion includes a relational threshold.

10. A program storage device readable by machine, tangibly embodying a program of instructions executable by the machine to query data from an inferencing-enabled metadata system, as recited in claim 6.

11. A system which registers and stores data and is responsive to queries through management of an inferencing-enabled metadata, comprising:
an intelligent database, which receives data or queries and manages one or more data models;
an ontology management system associated with the intelligent database which receives and stores classes of information related to a data model therein to be employed in satisfying queries; and
a relational database associated with the intelligent database which receives and stores attribute schema for instances of the class having at least one attribute value linked with the class in the ontology management system.

12. The system as recited in claim 11, wherein the data model is distributed between the ontology management system and the relational database.

13. The system as recited in claim 11, wherein the class is associated with existing classes stored in the ontology management system.

14. The system as recited in claim 11, wherein the. intelligent database receives queries having and inferencing portion and an attribute predicate portion.

15. The system as recited in claim 14, wherein the intelligent database issues an inferencing query to an ontology management system and retrieves inferencing results.

16. The system as recited in claim 14, wherein the intelligent database issues a relational query by combining the inferencing results and the attribute predicate portion.
